(19) United States
(12) Patent Application Publication
(10) Pub. No.: US 2024/0233202 A9
(43) Pub. Date: Jul. 11, 2024

(54) NFT INFORMATION PROVIDING SYSTEM AND NFT INFORMATION PROVIDING METHOD

(71) Applicant: Samsung Display Co., LTD., Yongin-si (KR)

(72) Inventor: DONG-HYUN KIM, Yongin-si (KR)

(21) Appl. No.: 18/234,446

(22) Filed: Aug. 16, 2023

(30) Foreign Application Priority Data
Oct. 20, 2022 (KR) 10-2022-0135918

(51) Int. Cl. G06T 11/00; G06T 7/00

(52) U.S. Cl. CPC G06T 11/00; G06T 7/97; G06T 2200/24; G06T 2207/20081; G06T 2207/20084

(57) ABSTRACT

A non-fungible token (NFT) information providing system includes: a first server configured to generate a virtual image, a second server configured to store NFT information, and a display device configured to communicate with the first server and the second server. The display device includes a sensing unit configured to sense an NFT object, a comparison unit including an image comparison processor and configured to determine the NFT information corresponding to the NFT object, from the second server using image comparison algorithm implemented by the image comparison processor, and a display unit configured to display the virtual image and the NFT information.

This application claims priority to Korean Patent Application No. 10-2022-0135918, filed on Oct. 20, 2022, and all the benefits accruing therefrom under 35 U.S.C. § 119, the content of which in its entirety is herein incorporated by reference.

### BACKGROUND

The present disclosure relates to a non-fungible token (“NFT”) information providing system and NFT information providing method having enhanced reliability.

A virtual image display device, which is worn on the body of a user to provide a user with virtual reality (“VR”) or augmented reality (“AR”), is being developed. For example, there is a head-mounted display worn on the head or an eyeglasses-type display device. The user may be provided with a new virtual image different from a real world through a virtual image display device, or may visually and concurrently recognize an actual object in the real world and the virtual image.

### SUMMARY

The present disclosure provides a non-fungible token (NFT) information providing system and NFT information providing method having enhanced reliability.

An embodiment of the invention provides a non-fungible token (NFT) information providing system including: a first server configured to generate a virtual image; a second server configured to store NFT information; and a display device configured to communicate with the first server and the second server. The display device includes: a sensing unit configured to sense an NFT object; a comparison unit including an image comparison processor and configured to determine the NFT information corresponding to the NFT object, from the second server using image comparison algorithm implemented by the image comparison processor; and a display unit configured to display the virtual image and the NFT information.

In an embodiment, the second server may include: an original server configured to store an original image of the NFT object; and an exchange server configured to store transaction information about the NFT object.

In an embodiment, the virtual image may include a virtual reality (VR) image, the first server may render the NFT object to generate a first image, and the display unit may display the first image, and displays the NFT information with the first image.

In an embodiment, the virtual image may include an augmented reality (AR) image, and the display unit may display the NFT information with a second image corresponding to the NFT object.

In an embodiment, the NFT information may include information regarding an owner of the NFT, a stake of the NFT, and a type of the NFT.

In an embodiment, the image comparison processor may include the original image stored in the second server with the NFT object to determine whether the original image is similar to the NFT object, and determines the NFT information corresponding to the original image on the basis of the original image.

In an embodiment, the display unit may operate in a first mode, a second mode, or a third mode, wherein in the first mode, the NFT information is constantly displayed; in the second mode, the NFT information is not displayed; and in the third mode, the NFT information is displayed when an image corresponding to the NFT object is selected.

In an embodiment, the image comparison processor may implement artificial intelligence model configured to machine-learn the NFT object to determine the NFT information corresponding to the NFT object.

In an embodiment, the artificial intelligence model may include a deep neural network.

In an embodiment, the virtual image and the NFT information may be concurrently displayed in real time.

In an embodiment of the invention, an NFT information providing system includes: a first server configured to generate a virtual image; a second server configured to communicate with the first server, and store NFT information; and a display device configured to communicate with the first server and sense an NFT object, where the first server receives the NFT information corresponding to the NFT object from the second server. The display device includes: a sensing unit configured to sense the NFT object; and a display unit configured to display the virtual image and the NFT information.

In an embodiment, the first server and the second server may communicate in real time.

In an embodiment, the virtual image may include a virtual reality (VR) image, the first server may render the NFT object to generate a first image, and the display unit may display the first image with the NFT information.

In an embodiment, the virtual image may include an augmented reality (AR) image, and the display unit may display the NFT information with a second image corresponding to the NFT object.

In an embodiment, the second server may include: an original server configured to store an original image of the NFT object; and an exchange server configured to store transaction information about the NFT object.

In an embodiment of the invention, an NFT information providing method including: sensing, by a display device, an NFT object; generating, by a first server, a virtual image; determining NFT information, corresponding to the NFT object, from a second server in which the NFT information is stored; and displaying, by the display device, the virtual image and the NFT information.

In an embodiment, the determining of the NFT information may include receiving, by the display device, the NFT information.

In an embodiment, the determining of the NFT information may include receiving, by the first server, the NFT information.

In an embodiment, the virtual image may include a virtual reality (VR) image, the generating of the virtual image may further include rendering the NFT object to generate a first image, and the displaying of the virtual image and the NFT information may include displaying the NFT information with the first image.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1 illustrates an NFT information providing system according to an embodiment of the invention;

FIG. 2 is a block diagram of a display device according to an embodiment of the invention;

FIG. 3 is a flowchart illustrating an NFT information providing method according to an embodiment of the invention;

FIG. 4 illustrates a display device and a virtual image provided by the display device according to an embodiment of the invention;

FIG. 5A is a perspective view of a figure of a user wearing a head-mounted device including a display device according to an embodiment of the invention;

FIG. 5B illustrates a virtual image provided by the display device according to an embodiment of the invention; and

FIG. 6 illustrates an NFT information providing system according to an embodiment of the invention.

### DETAILED DESCRIPTION

It will be understood that when an element or layer is referred to as being “on”, “connected to” or “coupled to” another element or layer, it can be directly on, connected or coupled to the other element or intervening third elements may be present.

Like reference numerals in the drawings refer to like elements. In addition, in the drawings, the thickness and the ratio and the dimension of the element are exaggerated for effective description of the technical contents. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” The term “and/or” includes any and all combinations of one or more of the associated items.

Terms such as “first”, “second”, and the like may be used to describe various components, but these components should not be limited by the terms. These terms are only used to distinguish one element from another. For instance, a first component may be referred to as a second component, or similarly, a second component may be referred to as a first component, without departing from the scope of the present disclosure. The singular expressions include plural expressions unless the context clearly dictates otherwise.

In addition, the terms such as “under”, “lower”, “on”, and “upper” are used for explaining associations of items illustrated in the drawings. The terms are used as a relative concept and are described with reference to the direction indicated in the drawings.

It should be understood that the terms “comprise” or “have” are intended to specify the presence of stated features, integers, steps, operations, elements, components, or combinations thereof in the disclosure, but do not preclude the presence or addition of one or more other features, integers, steps, operations, elements, components, or combinations thereof.

Unless otherwise defined, all terms (including technical and scientific terms) used herein have the same meaning as commonly understood by one of ordinary skill in the art to which example embodiments belong. In addition, it will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments of the invention will be described with reference to the accompanying drawings.

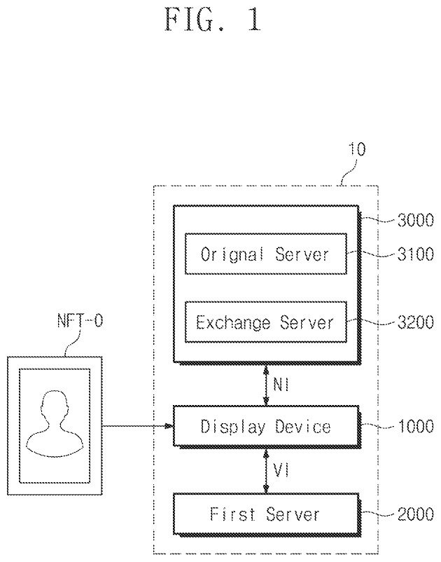

FIG. 1 illustrates an NFT information providing system according to an embodiment of the invention.

Referring to FIG. 1, an NFT information providing system 10 may include a display device 1000, a first server 2000, and a second server 3000.

The display device 1000 may be activated in response to an electrical signal. The display device 1000 may implement virtual reality (VR) or augmented reality (AR). For example, the display device 1000 may provide an image of a virtual world different from the real world visually recognized by a user, or provide an image of the real world visually recognized by the user, and a virtual image or information. The display device 1000 may shows the user a virtual world different from the actual world in which the user is present.

The display device 1000 may be implemented by various apparatuses including a smartphone, a mobile phone, a smart TV, a smart watch, an electronic wrist watch, a set-top box, a tablet PC, a digital camera, a camcorder, a laptop computer, a desktop computer, an electronic book terminal, a digital broadcast terminal, a Personal Digital Assistant (“PDA”), a Portable Multimedia Player (“PMP”), a navigator, an MP3 player, a wearable device, an air conditioner, a microwave oven, an audio player, a DVD player or the like.

The display device 1000 may sense an NFT object NFT-O from the outside. The NFT object NFT-O may include various objects such as clothing, an accessory, a building, a vehicle, a pet, a work of art or the like. The NFT object NFT-O may be an analog object registered as an NFT.

An NFT, namely, a non-fungible token may mean a blockchain-based token that cannot be exchanged or replicated, and is unique and scarce. Every fungible cryptocurrency such as a bitcoin has the same value to be 1:1 exchangeable, while every NFT is marked with a unique recognition value to have a non-fungible value and characteristics. An NFT technology, which imprints a unique serial number, can be applied to a digitizable asset to generate an (digital) asset that is not possibly replicated, that is, only one in the world. NFT-applicable assets range from digital content including a video, an image, a sound, text or the like, to a work of art, collection, a game item, a phoneme, various sorts of products, and property, etc.

The display device 1000 may communicate with the first server 2000 and the second server 3000. The display device 1000 may receive a virtual image VI from the first server 2000. The display device 1000 may display the virtual image VI to the user. The display device 1000 may receive NFT information NI from the second server 3000. The display device 1000 may link the NFT information NI with the virtual image VI to display the linked result to the user. Description thereabout will be provided later.

The first server 2000 may generate the virtual image VI. The first server 2000 may be a server configured to provide a virtual realty platform. The first server 2000 may be linked with the display device 1000 to provide a virtual digital space to users. For example, the first server 2000 may provide the users with the virtual image VI to service the virtual reality platform through an application executed in the display device 1000. Here, the virtual image VI may include a VR image or an AR image.

In the specification, the “server” may mean a server for operating external devices or external servers as a type of a server communicating with the external devices (e.g., user devices) or the external servers (other than itself) over a network. The server in an embodiment of the invention may be implemented using a web server program provided in various ways according to an operation system such as DOS, Window, Linux, Unix, Macintosh or the like.

The NFT information NI may be stored in the second server 3000. The NFT information NI may include an owner of the NFT, a stake of the NFT, and the type of the NFT.

The second server 3000 may include an original server 3100 and an exchange server 3200. In FIG. 1, an example is illustrated that the original server 3100 and the exchange server 3200 are provided as one server, but the original server 3100 and the exchange server 3200 according to an embodiment of the invention is not limited thereto. For another example, the original server 3100 and the exchange server 3200 may be separately provided.

In the original server 3100, an original image of the NFT object NFT-O may be stored, the NFT object NFT-O being tokenized into the NFT using the blockchain technology. For example, binary information about the image may be stored in the original server 3100. Since the original image of the NFT object NFT-O is marked with a unique number through tokenization into the NFT, replication is not possible without permission, and the original image may be recorded in a blockchain network to be safely protected. Accordingly, the value of the NFT object NFT-O increases to make transaction possible.

In other words, the NFT means a token that is not fungible. The NFT technology using the blockchain cryptocurrency technology is stored in a digital file to be issued only once, and all transactions are recorded in the blockchain to make forgery or falsification not possible. Accordingly, the originality for the digital file is accepted and the ownership is given. Therefore, a system capable of protecting the right (e.g., copyright, etc.) for the digital file on the Internet may be constructed.

The blockchain network may communicate with the original server 3100. The blockchain network may be a ledger management technology that a plurality of nodes participate and replicate data in a chain-type. The participators may verify transactions occurring from other nodes, and collect the transactions to generate one block. The generated block includes the hash values that a previous block has had. Accordingly, when a specific value of the previous block changes, the hash values, which would be included in subsequent blocks, of the previous block are also required to be changed, and thus it is not possible for a someone to arbitrarily change or delete data. During block propagation, there may occur a case where various blocks having different hash values are propagated concurrently. At the moment of the occurrence of the case, the blocks are considered as normal blocks. However, as time goes on, among blocks having the normal blocks as parents, only blocks in a chain up till the last block are admitted as normal blocks.

The transaction information about the NFT object NFT-O may be stored in the exchange server 3200. The exchange server 3200 may be an NFT market server configured to trade the NFT.

Such an NFT is a kind of digital data using blockchain and has the ‘non-fungible’ feature. The NFT is digital data with a survey report or a certificate of possession that cannot be forged, and can be traded as an asset through the exchange.

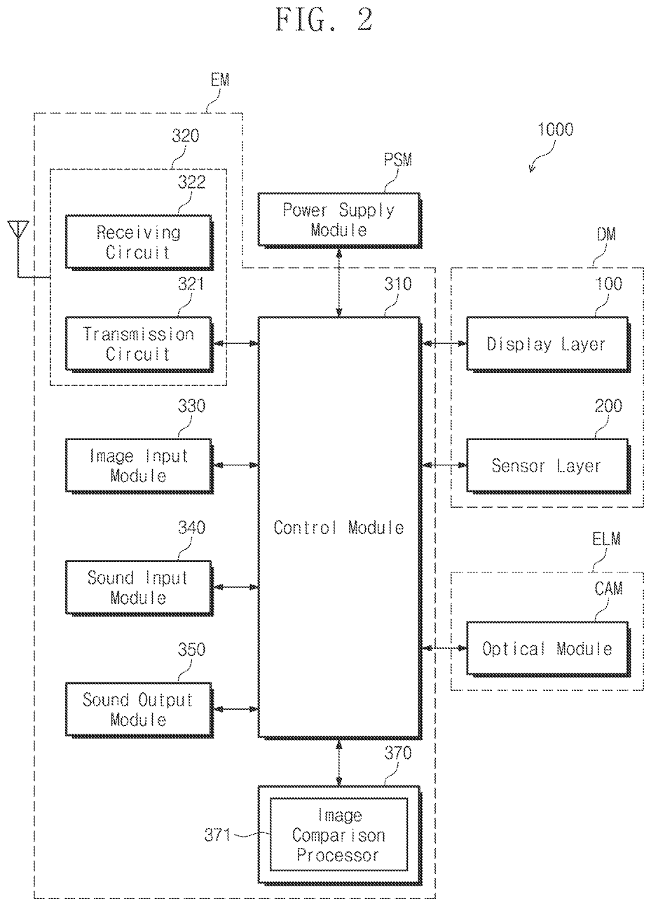

FIG. 2 is a block diagram of the display device according to an embodiment of the invention.

Referring to FIG. 2, the display device 1000 may include an electronic module EM, a power module PSM, a display unit DM, and a sensing unit ELM.

The electronic module EM may include a control module 310, a wireless communication module 320, an image input module 330, a sound input module 340, a sound output module 350, a comparison unit 370 and the like. Each of the components may be mounted on a circuit board, and electrically connected through a flexible circuit board. The electronic module EM may be electrically connected with the power module PSM.

The control module 310 may control the entire operation of the display device 1000. For example, the control module 310 may activate or deactivate the display module DM in response to a user input. The control module 310 may control the image input module 330, the sound input module 340, the sound output module 350 or the like, in response to the user input. The control module 310 may include at least one microprocessor.

The wireless communication module 320 may transmit/receive a wireless signal to/from another terminal using a Bluetooth or WiFi line. The wireless communication module 320 may transmit/receive a voice signal using a typical communication line. The wireless communication module 320 may include a transmission circuit 321 that modulates a signal to be transmitted, and transmits the modulated signal and a receiving circuit 322 that demodulates a received signal.

The image input module 330 may process an image signal to convert the processed image signal into image data displayable on the display module DM.

The sound input module 340 may receive an external sound signal through a microphone in a recording mode or a voice recognition mode to convert the sound signal to electrical voice data.

The sound output module 350 may perform conversion on sound data received from the wireless communication module 320 or sound data stored in a memory, and outputs the converted result to the outside.

The comparison unit 370 may include an image comparison processor 371. The comparison unit 370 may determine, on the basis of image comparison algorithm implemented by the image comparison processor 371, NFT information NI (see FIG. 1), corresponding to the NFT object NFT-O (see FIG. 1), from the second server 3000 (see FIG. 1).

The image comparison processor 371 may compare the original image stored in the second server 3000 (see FIG. 1) with the NFT object NFT-O (see FIG. 1) to determine whether the original image is similar to the NFT object NFT-O, and determine corresponding NFT information NI (see FIG. 1) on the basis of the original image.

The image comparison processor 371 may include a hardware or software structure specified for artificial intelligence model processing and configured to machine-learn the NFT object NFT-O to determine the NFT information NI corresponding to the NFT object NFT-O.

The artificial intelligence model may mean the intelligence model being artificial or a methodology capable of making the artificial intelligence, and the machine learning may mean a methodology for defining various issues dealt with in the field of artificial intelligence model and solving the defined issues. The machine learning may be defined as an algorithm that enhances the performance of a certain task through a steady experience of the task.

The artificial intelligence model may include a deep neural network (“DNN”). However, this is merely an example, and the artificial intelligence model may further include a convolutional neural network (“CNN”), a recurrent neural network (“RNN”), a bidirectional recurrent deep neural network (“BRDNN”) or the like.

The deep neural network may be designed to simulate the structure of the brain of a human on the image comparison processor 371. The deep neural network is one of models used in the machine learning, and may mean a whole model of problem-solving ability, which is composed of artificial neurons (nodes) that form a network by combining synapses. The deep neural network may be defined by a connection pattern between neurons in different layers, a learning process for updating model parameters, and an activation function for generating an output value.

The deep neural network may include an input layer, an output layer, and at least on hidden layer. Each layer includes one or more neurons, and the deep neural network may include synapses that connect neurons to neurons. In the deep neural network, each neuron may output a function values of the activation function for input signals, weights, and deflections that are input through the synapses.

The deep neural network may be trained according to supervised learning. The purpose of the supervised learning may be to find a predetermined answer through an algorithm. Accordingly, the deep neural network based on the supervised learning may include a form for inferring a function from training data. Labeled samples may be used for training in the supervised learning. When the training data is input to the deep neural network, the labeled samples may mean target output values that should be inferred by the deep neural network.

According to the algorithm, a series of training data and target output values corresponding thereto are received, errors are found by training of comparing actual output values with target output values for the input data, and the algorithm may be corrected on the basis of the training result.

However, this is merely an example, and the comparison unit 370 according to an embodiment of the invention may be omitted. Description thereabout will be provided later.

The power module PSM may supply power for the entire operation of the display device 1000. The power module PSM may include a typical battery device.

The display unit DM may include a display layer 100 and a sensor layer 200. The display layer 100 may display the virtual image VI (see FIG. 1) and the NFT information NI (see FIG. 1). The sensor layer 200 may receive an external input.

The sensing unit ELM may sense the NFT object NFT-O (see FIG. 1). For example, the image comparison processor 371 may compare, on the basis of the image comparison algorithm, the NFT object NFT-O (see FIG. 1) sensed by the sensing unit ELM with the original image and the NFT information NI from the second server 3000 (see FIG. 1) to extract an NFT having the similarity with the NFT object NFT-O by a set ratio or greater.

The comparison unit 370 may receive the NFT information NI (see FIG. 1) corresponding to the extracted NFT from the second server 3000 on the basis of the extracted NFT. The display unit DM may display the user with the NFT information NI (see FIG. 1) in connection with the virtual image VI.

The sensing unit ELM may include an optical module CAM. The optical module CAM may be an electrical component configured to output or receive an optical signal. The optical module CAM may transmit or receive the optical signal through a partial area of the display unit DM. For example, the optical module CAM may include a camera.

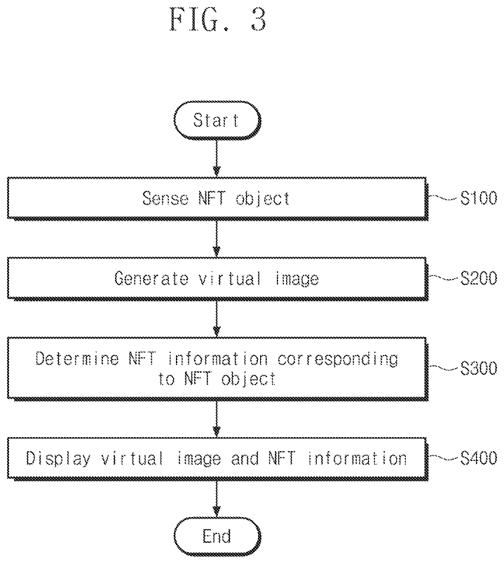

FIG. 3 is a flowchart illustrating an NFT information providing method according to an embodiment of the invention.

Referring to FIGS. 1 and 3, the sensing unit ELM of the display device 1000 may sense the NFT object NFT-O (step S100).

The first server 2000 may generate the virtual image VI (step S200). The first server 2000 may provided the virtual image VI to the display device 1000.

The comparison unit 370 may determine the NFT information NI corresponding to the NFT object NFT-O from the second server 3000 in which the NFT information NI is stored (step S300).

The display device 1000 may display the virtual image VI and the NFT information NI (step S400).

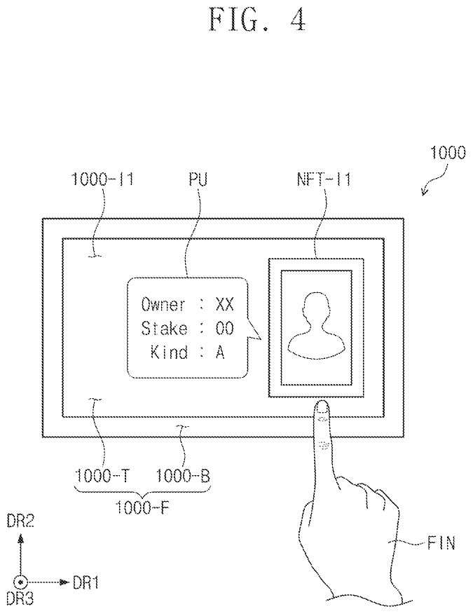

FIG. 4 illustrates the display device and the virtual image provided by the display device according to an embodiment of the invention.

Referring to FIGS. 1, 2, and 4, in the display device 1000, a display surface 1000-F parallel to a first direction DR1 and a second direction DR2 may be defined.

The display surface 1000-F may include an active area 1000-T and a non-active area 1000-B. The display device 1000 may display an image 1000-I1 towards a third direction DR3 in the active area 1000-T. The image 1000-I1 may include a still image as well as a moving image. The active area 1000-T in which the image 1000-I1 is displayed may correspond to the front surface of the display device 1000.

The non-active area 1000-B may be disposed adjacent to the active area 1000-T. The non-active area 1000-B may define the shape of the active area 1000-T. The non-active area 1000-B may surround the active area 1000-T. The non-active area 1000-B may have a prescribed color. However, this is merely an example, and the non-active area 1000-B according to an embodiment of the invention may be omitted in another embodiment.

The display unit DM of the display device 1000 may display the image 1000-I1. The image 1000-I1 may include the virtual image VI and an NFT image NFT-I1.

The virtual image VI may express a three-dimensional virtual image space, a four-dimensional virtual image space, or a two-dimensional virtual image space. The virtual image VI may include an AR image.

The display unit DM may display the NFT object NFT-O imaged by the optical module CAM as the NFT image NFT-I1. The NFT image NFT-I1 may be a digital image obtained by digitizing a real work image produced by an artist in offline on the basis of imaging or the like.

In another example, the NFT image NFT-I1 may be a digital image produced by an artist on the basis of an online computing device, such as a PC, a tablet, a notebook computer, a smartphone or the like.

The comparison unit 370 may receive the NFT information NI corresponding the extracted NFT from the second server 3000 on the basis of the extracted NFT having the similarity with the NFT object NFT-O by the set ratio or greater. The display unit DM may display the user with the NFT information NI in connection with the virtual image VI. Here, the virtual image VI and the NFT information NI may be concurrently displayed in real time.

The NFT information NI may include an owner of the NFT, a stake of the NFT, and the type of the NFT. However, this is an example, and the configuration included in the NFT information NI according to an embodiment of the invention is not limited thereto. For another example, the NFT information NI may further include a price of the NFT, transaction information about the NFT, the name of the NFT, a production date or the like.

The display unit DM may display the NFT information NI with the NFT image NFT-I1 corresponding to the NFT object NFT-O. The NFT information NI may be provided in the form of a popup image PU.

The display device 1000 according to an embodiment of the invention may sense a user input FIN applied from the outside through the sensor layer 200. The user input includes various types of external inputs including a part of the user's body, light, heat, a pen, pressure or the like. In addition, the display device 1000 may sense the user input FIN applied to a side surface or the rear surface of the display device DA according to the structure of the display device 1000, but is not limited to any one embodiment.

The display unit DM may operate in a first mode, a second mode, or a third mode. In the first mode, the NFT information NI may be constantly displayed. In the second mode, the NFT information NI may not be displayed. In the third mode, the NFT information NI may be displayed when the NFT image NFT-I1 is selected through the external input FIN.

According to the embodiment of the invention, the user may easily recognize a product, of which the NFT is registered, through the NFT image NFT-I1 displayed in an environment in which the virtual image is displayed. The comparison unit 370 may determine the NFT information NI corresponding to the NFT object NFT-O from the second server 3000, and figure out the NFT information NI corresponding to the NFT object NFT-O. The display unit DM may display the NFT information NI in connection with the virtual image VI to the user. The user may easily confirm and be provided with the information about the NFT object NFT-O in the virtual environment. Accordingly, the NFT information providing system and NFT information providing method having enhanced reliability may be provided.

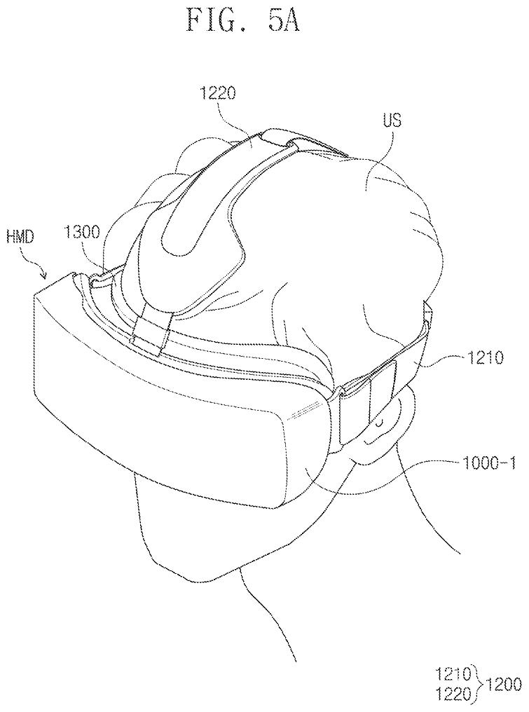

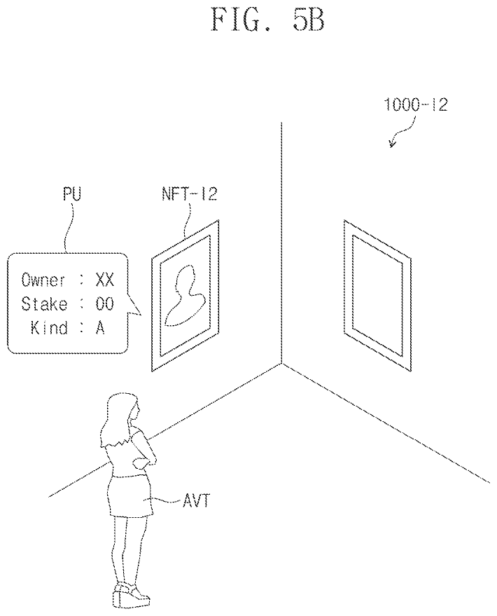

FIG. 5A is a perspective view showing that a user wears a head mounted device including a display device according to an embodiment of the invention, and FIG. 5B illustrates a virtual image provided by the display device according to an embodiment of the invention. In description about FIG. 5B, like reference numerals are given to the elements described with reference to FIG. 4, and descriptions about the elements will be omitted.

Referring to FIGS. 1, 2, 5A, and 5B, a display device 1000-1 may be provided to the user in various types. For example, the display device 1000-1 may constitute a wearable device to provide an image to the user. For example, the display device 1000-1 may have a form of ahead-mounted display mounted on the head of the user, or an eyeglasses-type display that the user can wear like eyeglasses. FIG. 5A shows an example view of the head-mounted device HMD worn by the user US.

The head-mounted device HMD may include the display device 1000-1, a wearing unit 1200, and a cushion unit 1300. The display device 1000-1 may cover the eyes of the user US so as to correspond to the left and right eyes of the user US.

The head-mounted device HMD may provide an image 1000-I2 to the user US through the display device 1000-1 in a state where the actual peripheral view of the user US is blocked. The user US wearing the head-mounted device HMD may be more easily immersed in virtual reality through the display device 1000-1.

The wearing unit 1200 is combined with the display device 1000-1 to enable the user US to easily wear the display device 1000-1. FIG. 5A illustrates an example wearing unit 1200 including a main strap 1210 surrounding the head circumference of the user US, and an upper strap 1220 connecting the display device 1000-1 and the main strap 1210 along the upper part of the head.

The main strap 1210 may tightly fix the display device 1000-1 to the head of the user US. The upper strap 1220 may prevent the display device 1000-1 from sliding down, and distribute the weight of the display device 1000-1 to further improve wearing comfort.

FIG. 5A illustrates an example form in which the length of each of the main strap 1210 and the upper strap 1220 is adjustable, but the embodiment of the invention is not limited thereto. For another example, each of the main strap 1210 and the upper strap 1220 may have an elastic strap instead of the length-adjustable portion.

If the display device 1000-1 may be fixed to the user US, the wearing unit 1200 may be deformed to various types other than the shown in FIG. 5A. For example, the upper strap 1220 may be omitted. In addition, the wearing unit 1200 in another embodiment may be modified in various types such as a helmet combined with the display device 1000-1, eyeglass temples combined with the display device 1000-1 or the like.

The cushion unit 1300 may be disposed to contact the face of the user US while the user US wears the head-mounted device HMD. The cushion unit 1300 may have a freely deformable shape and absorb an impact applied to the head-mounted device HMD. For example, the cushion unit 1300 may be composed of a polymer resin, foam sponge or the like, and include polyurethane, polycarbonate, polypropylene, polyethylene and the like. However, the material of the cushion unit 1300 is not limited thereto. The cushion unit 1300 may be omitted in another embodiment.

The display unit DM of the display device 1000-1 may display the image 1000-I2. The image 1000-I2 may include the virtual image VI and an NFT image NFT-I2.

The virtual image may express a three-dimensional virtual image space, a four-dimensional virtual image space, or a two-dimensional virtual image space. The virtual image may include a VR image.

The user US may move in the three-dimensional virtual image space using avatar AVT.

The optical module CAM may image the NFT object NFT-O to provide the image to the first server 2000. The first server 2000 may render the NFT object NFT-O to generate the NFT image NFT-I2.

The comparison unit 370 may receive the NFT information NI corresponding the extracted NFT from the second server 3000 on the basis of the extracted NFT having the similarity with the NFT object NFT-O by the set ratio or greater. The display unit DM may display the user with the NFT information NI in connection with the virtual image VI. Here, the virtual image VI and the NFT information NI may be concurrently displayed in real time.

The display unit DM may display the NFT information NI with the NFT image NFT-I2 corresponding to the NFT object NFT-O. The NFT information NI may be provided in a popup image PU form.

The display unit DM may operate in a first mode, a second mode, or a third mode. In the first mode, the NFT information NI may be constantly displayed. In the second mode, the NFT information NI may not be displayed. In the third mode, the NFT information NI may be displayed when the NFT image NFT-I2 is selected through the avatar AVT.

According to the embodiment of the invention, the user US may easily recognize a product, of which an NFT is registered, through the NFT image NFT-I2 displayed in an environment in which the virtual image VI is displayed. The comparison unit 370 may determine the NFT corresponding to the NFT object NFT-O from the second server 3000, and figure out the NFT information NI corresponding to the NFT object NFT-O. The display unit DM may display the user US with the NFT information NI in connection with the virtual image VI. The user US may easily confirm and be provided with the information about the NFT object NFT-O in the virtual environment. Accordingly, the NFT information providing system and NFT information providing method having enhanced reliability may be provided.

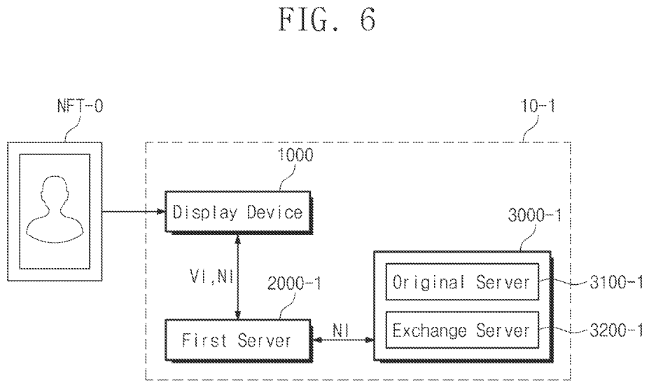

FIG. 6 illustrates an NFT information providing system according to an embodiment of the invention. In description about FIG. 6, like reference numerals are given to the elements described with reference to FIG. 1, and descriptions thereabout will be omitted.

Referring to FIGS. 2 and 6, the NFT information providing system 10-1 may include the display device 1000, a first server 2000-1, and a second server 3000-1.

The display device 1000 may communicate with the first server 2000-1. The display device 1000 may receive the virtual image VI and the NFT information NI from the first server 2000-1. The display device 1000 may link the NFT information NI with the virtual image VI to display the linked result to the user.

The sensing unit ELM of the display device 1000 may sense the NFT object NFT-O.

The first server 2000-1 may generate the virtual image VI. The first server 2000-1 may be a server configured to provide a virtual realty platform. The first server 2000-1 may communicate with the second server 3000-1. The first server 2000-1 and the second server 3000-1 may communication with each other in real time.

The NFT information may be stored in the second server 3000-1. The second server 3000-1 may include an original server 3100-1 and an exchange server 3200-1. In FIG. 1, the example is illustrated that the original server 3100-1 and the exchange server 3200-1 are provided as one server, but the original server 3100-1 and the exchange server 3200-1 according to an embodiment of the invention is not limited thereto. For another example, the original server 3100-1 and the exchange server 3200-1 may be separately provided.

In the original server 3100-1, the original image of the NFT object NFT-O may be stored, the NFT object NFT-O being tokenized into an NFT using the blockchain technology. The transaction information about the NFT object NFT-O may be stored in the exchange server 3200-1.

The first server 2000-1 may receive in real time the NFT information NI corresponding to the NFT object NFT-O from the second server 3000-1. When generating the virtual image VI, the first server 2000-1 may include the NFT information NI received from the second server 3000-1 in the NFT image NFT-I1 (see FIG. 4) of the NFT object NFT-O. Here, the comparison unit 370 of the display device 1000-1 may be omitted.

The display unit DM of the display device 1000 may display the virtual image VI and the NFT information NI.

According to the embodiment of the invention, the user may easily recognize a product, of which an NFT is registered, through the NFT image NFT-I1 displayed in an environment in which the virtual image VI is displayed. The first server 2000-1 may receive the NFT information NI corresponding to the NFT object NFT-O from the second server 3000. The display unit DM may display the user with the NFT information NI in connection with the virtual image VI. The user may easily confirm and be provided with the information about the NFT object NFT-O in the virtual environment. Accordingly, the NFT information providing system 10-1 and NFT information providing method having enhanced reliability may be provided.

The NFT information providing system and NFT information providing method may be constructed with a computer program. Codes and/or code segments constituting such a program may be easily reasoned by a computer programmer in the art. The program may be stored in a computer readable recording medium, and read and executed by a device to implement the above-described method. Such a recording medium may include a magnetic recording medium, an optical recoding medium or the like.

According to the described above, the user may easily recognize a product, of which an NFT is registered, through the NFT image displayed in an environment in which the virtual image is displayed. The display device may determine the NFT, corresponding to the NFT object, from the second server, and figure out the NFT information corresponding to the NFT object. The display device may link the NFT information with the virtual image to display the linked NFT information to the user. The user may easily confirm and be provided with the information about the NFT object in the virtual environment. Accordingly, the NFT information providing system and NFT information providing method having enhanced reliability may be provided.

Alternatively, according to the described above, the user may easily recognize a product, of which an NFT has been registered, through the NFT image displayed in an environment in which the virtual image is displayed. The first server may receive the NFT information corresponding to the NFT object from the second server. The display device may link the NFT information with the virtual image to display the linked NFT information to the user. The user may easily confirm and be provided with the information about the NFT object in the virtual environment. Accordingly, the NFT information providing system and NFT information providing method having enhanced reliability may be provided.

While this invention has been described with reference to exemplary embodiments thereof, it will be clear to those of ordinary skill in the art to which the invention pertains that various changes and modifications may be made to the described embodiments without departing from the spirit and technical area of the invention as defined in the appended claims and their equivalents. Thus, the scope of the invention shall not be restricted or limited by the foregoing description, but be determined by the broadest permissible interpretation of the following claims.

What is claimed is:

1. A non-fungible token (NFT) information providing system comprising:
a first server configured to generate a virtual image;
a second server configured to store NFT information; and
a display device configured to communicate with the first server and the second server,
wherein the display device comprises:
a sensing unit configured to sense an NFT object;
a comparison unit comprising an image comparison processor and configured to determine the NFT information corresponding to the NFT object from the second server using image comparison algorithm implemented by the image comparison processor; and
a display unit configured to display the virtual image and the NFT information.

2. The NFT information providing system according to claim 1, wherein the second server comprises:
an original server configured to store an original image of the NFT object; and
an exchange server configured to store transaction information about the NFT object.

3. The NFT information providing system according to claim 1,
wherein the virtual image comprises a virtual reality (VR) image,
the first server renders the NFT object to generate a first image, and
the display unit displays the first image, and displays the NFT information with the first image.

4. The NFT information providing system according to claim 1, wherein the virtual image comprises an augmented reality (AR) image, and the display unit displays the NFT information with a second image corresponding to the NFT object.

5. The NFT information providing system according to claim 1, wherein the NFT information comprises information regarding an owner of the NFT, a stake of the NFT, and a type of the NFT.

6. The NFT information providing system according to claim 1, wherein the image comparison processor compares the original image stored in the second server with the NFT object to determine whether the original image is similar to the NFT object, and determines the NFT information corresponding to the original image on the basis of the original image.

7. The NFT information providing system according to claim 1, wherein the display unit operates in a first mode, in a second mode, or in a third mode,
wherein in the first mode, the NFT information is constantly displayed,
in the second mode, the NFT information is not displayed, and
in the third mode, the NFT information is displayed when an image corresponding to the NFT object is selected.

8. The NFT information providing system according to claim 1, wherein the image comparison processor implements an artificial intelligence model configured to machine-learn the NFT object to determine the NFT information corresponding to the NFT object.

9. The NFT information providing system according to claim 8, wherein the artificial intelligence model comprises a deep neural network.

10. The NFT information providing system according to claim 1, wherein the virtual image and the NFT information are concurrently displayed in real time.

11. A non-fungible token (NFT) information providing system comprising:
a first server configured to generate a virtual image;
a second server configured to communicate with the first server, and store NFT information; and
a display device configured to communicate with the first server and sense an NFT object,
wherein the first server receives the NFT information corresponding to the NFT object from the second server, and
wherein the display device comprises:
a sensing unit configured to sense the NFT object; and
a display unit configured to display the virtual image and the NFT information.

12. The NFT information providing system according to claim 11, wherein the first server and the second server communicate in real time.

13. The NFT information providing system according to claim 11,
wherein the virtual image comprises a virtual reality (VR) image,
the first server renders the NFT object to generate a first image, and
the display unit displays the first image with the NFT information.

14. The NFT information providing system according to claim 11, wherein the virtual image comprises an augmented reality (AR) image, and the display unit displays the NFT information with a second image corresponding to the NFT object.

15. The NFT information providing system according to claim 11, wherein the second server comprises:
an original server configured to store an original image of the NFT object; and
an exchange server configured to store transaction information about the NFT object.

16. A non-fungible token (NFT) information providing method comprising:
sensing, by a display device, an NFT object;
generating, by a first server, a virtual image;
determining NFT information corresponding to the NFT object, from a second server in which the NFT information is stored; and
displaying, by the display device, the virtual image and the NFT information.

17. The NFT information providing method according to claim 16, wherein the determining of the NFT information comprises receiving, by the display device, the NFT information.

18. The NFT information providing method according to claim 16, wherein the determining of the NFT information comprises receiving, by the first server, the NFT information.

19. The NFT information providing method according to claim 16,
wherein the virtual image comprises a virtual reality (VR) image,
the generating of the virtual image further comprises rendering the NFT object to generate a first image, and
the displaying of the virtual image and the NFT information comprises displaying the NFT information with the first image.

20. The NFT information providing method according to claim 16,
wherein the virtual image comprises an augmented reality (AR) image, and
the displaying of the virtual image and the NFT information comprises displaying the NFT information with a second image corresponding to the NFT object.
